(19) United States
(12) Patent Application Publication
(10) Pub. No.: US 2008/0147357 A1
(43) Pub. Date: Jun. 19, 2008

(54) System and method of assessing performance of a processor

(75) Inventor: Pieter Truter, North Vancouver (CA)

Correspondence Address: LAW OFFICES OF CHARLES W. BETHARDS, LLP, P.O. BOX 1622, COLLEYVILLE, TX, 76034, US

(73) Assignee: Iintrinisyc Software International

(21) Appl. No.: 12/001,817

(22) Filed: Dec. 13, 2007

Related U.S. Application Data
(60) Provisional application No. 60/875,052, filed on Dec. 15, 2006.
(60) Provisional application No. 60/918,492, filed on Mar. 16, 2007.

(51) Int. Cl. G06F 15/00

(52) U.S. Cl. 702/186

(57) ABSTRACT

Methods of and corresponding systems for assessing performance of a processor in a thread based system are discussed. One method comprises: registering with an operating system kernel as a coprocessor; capturing, responsive to the registering, thread events for the processor; managing memory allocation corresponding to a multiplicity of threads; monitoring thread activity for the multiplicity of threads; tracking thread run time and thread idle time based on the monitoring thread activity; and determining a performance level for the processor based on the thread activity.

### RELATED APPLICATIONS

This application claims the benefit under 35 U.S.C. Section 119(e) of the following U.S. provisional patent applications: Ser. No. 60/875,052 filed on Dec. 15, 2006 by Truter, entitled “Method of Determining Performance Consumption Information From Proprietary Operating Systems”; and Ser. No. 60/918,492 filed on Mar. 16, 2007 by Truter, entitled “Software For Determining Performance Consumption Information From Proprietary Operating Systems”, which applications are hereby incorporated herein by reference.

### FIELD OF THE INVENTION

This invention relates in general to processor performance and more specifically to techniques and systems for readily determining such performance in thread based systems.

### BACKGROUND OF THE INVENTION

Thread based systems or operating systems are known. The need to estimate processor performance is recognized. Processor performance is one way to assess whether or to what extent a processor is getting the tasks it is expected to accomplish finished in an appropriate time frame.

System or software application developers are routinely interested in the performance of their applications and this may be impacted by the processor running their application or at least gaining an understanding of processor performance may aid in developing the application.

Of course one way to solve a processor performance issue may be to use a more capable (faster, etc.) processor. Unfortunately, faster processors are more costly and generally consume more power and dissipate more heat. This can be a problem, particularly for battery powered applications.

It is known to essentially count processor cycles and use that as an estimate of performance; however this can be processor intensive with the counting representing an unacceptably large portion of the processor capability. Others attempt to look at processor idle time; but that approach may not allow one to understand why the processor is idle. Generally known approaches to determining processor performance may be burdensome or result in poor estimates.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts in a simplified and representative form, a high level diagram showing a performance kernel and relationships to other entities in an overall system, all in accordance with one or more embodiments;

FIG. 2 in a representative form, shows a performance kernel utilized for providing performance information to a Dynamic Voltage Frequency Scaling (DVFS) function in accordance with one or more embodiments;

FIG. 3 shows a flow chart illustrating representative methods of assessing performance of a processor in accordance with one or more embodiments;

FIG. 4 depicts a representative diagram of thread events and a sliding window for determining current performance in accordance with one or more embodiments;

FIG. 5 depicts a flow chart illustrating representative methods of assessing performance of a processor to provide a desired performance based on monitoring thread activity in accordance with one or more embodiments;

FIG. 6 illustrates additional detail for a portion of the interface between the performance kernel and a DVFS function in accordance with one or more embodiments; and

FIG. 7 shows a flow chart illustrating representative methods of implementing the interface at the DVFS function in accordance with one or more embodiments.

### DETAILED DESCRIPTION

In overview, the present disclosure concerns performance of processors in thread based system, e.g., embedded systems and the like, and more specifically techniques and apparatus for assessing performance that are arranged and constructed for determining present or current performance and from there desired performance levels. More particularly various inventive concepts and principles embodied in methods and systems will be discussed and disclosed. The methods and systems of particular interest may vary widely but include embedded systems such as found in cellular phones or other systems. In systems, equipment and devices that employ Dynamic Voltage Frequency Scaling (DVFS), the performance assessment and predictive methods and systems discussed and disclosed can be particularly advantageously utilized, provided they are practiced in accordance with the inventive concepts and principles as taught herein.

The instant disclosure is provided to further explain in an enabling fashion the best modes, at the time of the application, of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with software or firmware executing on processors or in integrated circuits (ICs) including possibly application specific ICs or ICs with integrated processing controlled by embedded software or firmware. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts of the various embodiments.

Referring to FIG. 1, a simplified and representative high level diagram showing a performance kernel and relationships to other entities in an overall system, all in accordance with one or more embodiments will be discussed and described. FIG. 1 shows a combination of hardware and software. A processor (processor hardware) 103 is depicted which is arranged and configured to execute an operating system (OS) kernel 105. In some system embodiments, e.g., some of those available from Microsoft and the like, a coprocessor 107 interfaces with the OS kernel 105 via a coprocessor manager 109. In such systems, the coprocessor manager 109 registers with the OS kernel and is operative thereafter to interface to the OS kernel and manage memory, etc on behalf of a coprocessor 107 and is provided with thread event information as shown by dotted arrow 111.

In the present system, a performance kernel (PK) or PK interface is run by the processor 103 or possibly another processor and operates as far as the OS kernel is concerned as a coprocessor. As part of installation and initialization on the relevant processor, the PK interface registers with the OS kernel as a coprocessor. As a coprocessor, the PK or PK interface 113 is provided with all coprocessor events as generated by the OS kernel. The OS kernel notifies coprocessors in the system each time a thread is created, switched in (alternatively enabled, activated, etc.), or switched out (alternatively disabled, inactivated, etc). Basically the interface with thread information represented by arrow 111 is replaced by the solid arrow 115 from the OS kernel to the PK interface 113 and by the solid arrow 117 from the PK interface to the coprocessor manager 109. Thus by registering as a coprocessor, the PK interface takes over the role of coprocessor and has access to all thread events (task management events) as provided by the OS kernel. From the OS kernels perspective the PK interface is the only coprocessor in the system.

In some embodiments the interface for the OS kernel is through global pointers to functions. These functions are called as needed by the OS kernel. The PK interface, when installed as the coprocessor interface, supersedes any existing registered coprocessor. The PK interface as installed and initialized, preserves the original coprocessor interface (if any) and redirects the calls to the PK interface routines. The PK interface routines then call the original coprocessor routines (if needed) once the PK interface has collected all the information needed by the PK interface. During registration, the PK interface also determines the memory or local storage that is needed for each thread as well as any other local memory needs (memory not specifically shown in FIG. 1). The memory or local storage that will be requested by the PK interface from the OS kernel will include any needs of a coprocessor (e.g., sufficient space to store coprocessor state information, etc) for a given thread as well as any memory needs on a per thread basis and otherwise to store thread information and performance information collected/generated by the PK interface 113.

Since the PK interface has access to all thread events it can keep track of or monitor thread activity in the OS kernel. The PK interface manages thread local storage or memory, and tracks one or more of thread run time, thread idle time, thread preemption, thread priority. With this information, the PK interface in varying embodiments can calculate or determine various performance levels for the processor or system, e.g., a current performance level or a new or desired (target) performance level. One or more of these performance levels can be provided to other applications or can be used to drive or control a DVFS function, such as a DVFS power supply for a processor.

The local storage which has been allocated is normally used for storing coprocessor state or context data (normally a snap shot of the coprocessor registers, etc.) and is also used by the PK to store thread information that is being tracked. The PK interface uses the local memory to store a thread Identifier (ID) (which is typically assigned by the OS kernel), a priority indication (all threads do not have equal priority), a unique thread ID (if the operating system reuses thread IDs), active or run time (time stamps can be used to determine amount of time that the thread spent in the running state up to the moment in time when the OS kernel switched to the next thread to run), preemption flag. The local memory or storage can also be used to support interfaces to other applications, i.e., PK stores performance levels which may be used by other applications.

The preemption flag in one or more embodiments of the PK is an in indication of why the thread was switched from a run or active state. E.g., if the preemption flag is set or true, the thread has run for its full time quantum (OS kernels tend to switch threads according to a schedule and this period between switches is often referred to as a quantum) and the OS kernel scheduled or switched to another thread. Typically in appropriately designed systems, a thread will run until it blocks waiting for some other event or resource. The preemption flag can thus indicate a thread has not had sufficient processing to complete all of its tasks. This information can be used to help determine or assess performance of a processor or system. For instance if the processor is very busy (and unable to handle the work load) the frequency of preemptions will ordinarily go up.

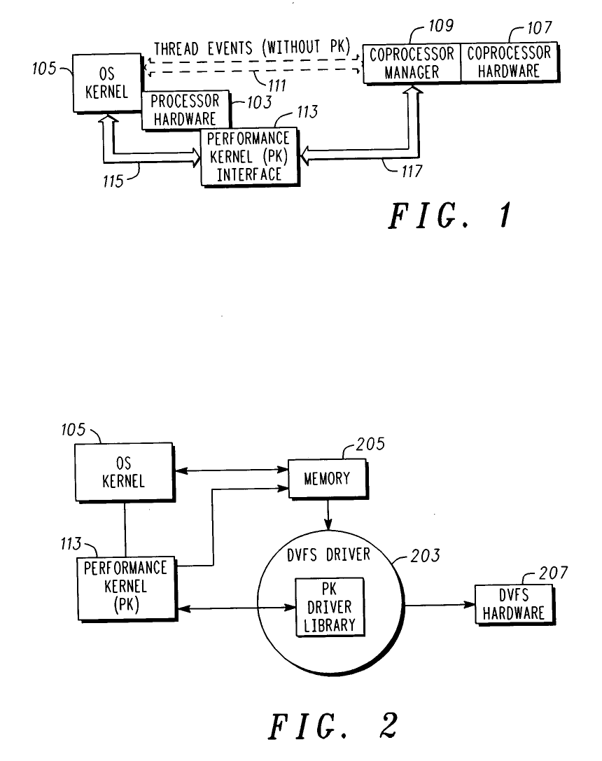

Referring to FIG. 2, a representative diagram of a performance kernel utilized for providing performance information to a Dynamic Voltage Frequency Scaling (DVFS) function in accordance with one or more embodiments will be briefly discussed and described. FIG. 2 shows the OS kernel 105 interfaced with the PK 113. The PK is registered as a coprocessor as above described and thus has access to and tracks thread activity information. Note that in this system there may or may not be any actual coprocessor or alternatively the PK interface may have one or more additional interfaces to coprocessors (not shown). As shown local memory 205 is accessible by the OS kernel and the PK interface as well as a Dynamic Voltage Frequency Scaling (DVFS) driver 203. The DVFS driver 203 interacts with DVFS hardware 207, e.g., to select the appropriate combination of voltage and clock rate or frequency for a processor.

Generally to operate a processor at higher clock rates, higher supply voltages will be necessary. A processor at higher clock rates or frequencies can execute more instructions in a given time period. However a processor consumes more power when operating at higher clock frequencies or rates, which can be problematic in a battery powered system or thermally challenged system. The appropriate voltage frequency combination is that which provides sufficient performance with the least amount of power consumption. The PK interface by providing appropriate (sufficiently accurate and timely) performance levels can be used to facilitate or control the voltage frequency choice and thus provide acceptable system performance at a minimum power consumption.

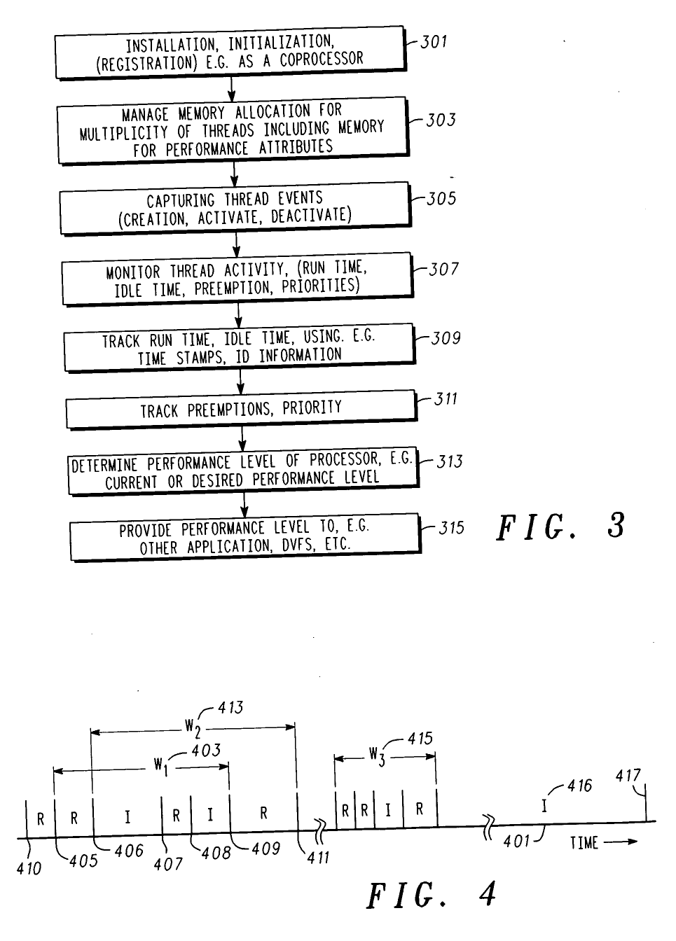

Referring to FIG. 3, a flow chart illustrating representative methods of assessing performance of a processor in accordance with one or more embodiments will be briefly discussed and described. The methods illustrated in FIG. 3 can be implemented in one or more of the structures or systems described with reference to FIG. 1 and FIG. 2 or other similarly configured and arranged structures.

FIG. 3 illustrates various embodiments of methods of assessing performance of a processor in a thread based system, which methods can be performed by the PK interface, etc. as discussed above. The methods begins at 301 with installation, initialization and registration, e.g., as a coprocessor, with an operating system (OS) kernel. Further, the flow chart shows managing memory allocation corresponding to a multiplicity of threads, e.g., all or most threads, and this includes additional memory for performance attributes or information as shown at 303. At 305 the method includes capturing (responsive to or as a result of the registering) thread events for the processor, e.g., thread creation, activation or deactivation. After the capturing, the method comprises at 307 monitoring thread activity, e.g., run time, idle time, preemptions, priorities, etc, for the multiplicity of threads. At 309 the flow chart shows tracking thread run time and thread idle time based in the monitoring thread activity. This may be facilitated by using time stamps, ID information. For example by storing the time when a thread is activated or enabled and the time when it is suspended or inactivated, the difference provides the run time for that thread. In many OS kernels a thread with a predetermined ID, such as “0” is understood to be an idle thread. The method as shown at 311 can also include tracking thread preemptions or preemption rate and thread priorities. Given this information, the methods further comprise determining a performance level, e.g., a current or desired performance level, for the processor based on the thread activity.

The determining a performance level can include determining a current performance level based on the monitoring thread activity. The determining a current performance level in various embodiment can comprises tracking thread run time and tracking thread idle time over a predetermined number of thread events. The tracking thread run time and the tracking thread idle time over a predetermined number of thread events can comprise using a sliding window that encompasses the predetermined number of thread events and updating the thread run time and thread idle time by any difference corresponding to an old thread event leaving the sliding window and a new thread event arriving in the sliding window (further discussed below with reference to FIG. 4).

As suggested above, the monitoring thread activity can comprises monitoring thread preemptions or monitoring thread priorities in one or more method embodiments.

The determining a performance level can comprises determining a desired performance level based on the thread activity. The determining a desired performance level can comprises determining a current performance level, where the current performance level corresponds to the thread run time and the thread idle time. Thus the desired performance level is dependent on the current performance level. For example by tracking thread run time and thread idle time the ratio of run time to total time can be determined and as this ratio gets closer to one (1) indicating the processor is very busy, it may be appropriate to increase the clock frequency as suggested by a higher desired performance level.

In one or more embodiments, the monitoring thread activity further comprises tracking thread preemption or preemption rate and the determining a desired performance level based on the thread activity further comprises determining a desired performance level based on the thread preemption. As the thread preemption rate increases the need for additional performance can increase. In additional embodiments, the monitoring thread activity further comprises tracking thread priority and the determining a desired performance level based on the thread activity further comprises determining a desired performance level based on the thread priority. For example, if more higher priority threads are running in a given time frame it may be appropriate to increase processor performance or vice a versa.

As shown at 315, the methods can further comprise providing the performance level to a predetermined memory location, i.e., where the performance level corresponds to a current performance level that may be of interest to another application. Or the methods can further comprises providing the performance level to a predetermined memory location, where the performance level corresponds to a desired performance level and where the desired performance level is available to a Dynamic Voltage/Frequency Scaling driver for use in or to set the performance level of the processor.

Referring to FIG. 4, a representative diagram of thread events and a sliding window for determining current performance in accordance with one or more embodiments will be briefly discussed and described. FIG. 4 shows time on the horizontal axis 401. The vertical lines are indicative of thread events (creation, activate, inactivate) and the spaces between the events is marked R for run or I for idle. A window W₁ 403 is depicted encompassing a predetermined number of thread events, i.e., four events 405-408 in this simplified diagram. An actual system may encompass tens of such events, e.g., one embodiment uses 16 thread events, with the number being a trade off between being responsive and capturing an average value for observed or current performance.

By tracking the aggregate or total run time and the aggregate or total idle time within the window an estimate of current performance can be determined as the ratio of the sum of Rs divided by (the sum of Rs plus sum of Is) or other appropriate ratio. As this ratio becomes larger the present or current performance is growing and vice-a-versa. If the observed or current performance becomes large or high enough that the system is not sufficiently responsive, a larger desired performance and thus higher clock frequency and supply voltage may be desired. When a new thread event 409 occurs an old or oldest thread event 410 leaves the sliding window. Note that updating the sum of Rs and sum of Is amounts to subtracting the R between 410 and 405 from the sum of Rs and adding the I between 408 and 409 to the sum of Is, rather than adding up hundreds of Rs and Is each time a new event occurs. Whenever a new thread event occurs the current performance can be updated.

When yet another thread event 411 occurs the window slides and becomes W₂ encompassing 406-409 and the respective Rs and Is. By observation one can see that W₂ is larger in time than W₁, i.e., the period or time span of the window grows as events occur less frequently and shrinks as events occur more frequently. In this instance updating the run time and idle time (sum of Rs and sum of Is) amounts to subtracting the R between 405 and 406 and adding the R between 409 and 411. A possible thread preemption occurs at 405 as adjacent active or run times are depicted. By tracking the rate at which these occur, e.g., as a percentage of the predetermined number an assessment of how busy the processor is can be obtained.

Further shown in FIG. 4 is W₃ 415 followed by a long period of time (I 416) before another thread event 417 occurs. The PK interface generally does not update the performance level when the system is idle and thus does not need to wake up the processor simply for performance level estimates, etc. It may be appropriate to have a fall back position wherein the desired performance is lowered after a sufficient time period without an update.

Thus, a method of assessing performance of a processor in a thread based system, can comprise managing memory allocation corresponding to a multiplicity of threads, monitoring thread activity for the multiplicity of threads, tracking, responsive to the monitoring thread activity, thread run time and thread idle time over a predetermined number of thread events; and determining a performance level for the processor based on the thread activity. The determining a performance level can occur at a first rate when the thread events occur at a first event rate and at a second rate when thread events occur at a second event rate. The tracking thread run time and the tracking thread idle time over a predetermined number of thread events can comprise using a sliding window that encompasses the predetermined number of thread events and updating the thread run time and thread idle time by any difference corresponding to an old thread event leaving the sliding window and a new thread event arriving in the sliding window. The determining a performance level can comprise determining a current performance level based on the monitoring thread activity.

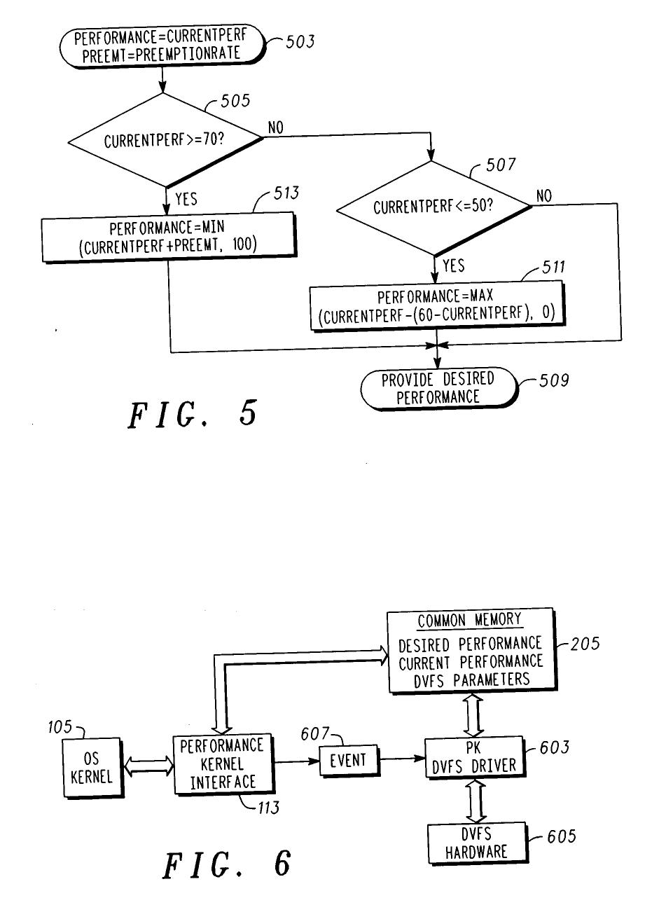

Referring to FIG. 5, a flow chart illustrating representative methods of assessing performance of a processor to provide a desired performance based on monitoring thread activity in accordance with one or more embodiments will be discussed and described. Desired performance is sometimes referred to as predicted performance and this can be quite complicated and can consider a number of attributes or factors. For example, run time, idle time, interrupt frequency (generated by various systems, preemption rates and other factors such as Direct Memory Access (DMA) activity, and limitations of the DVFS hardware or systems.

FIG. 5 will illustrate an example where the determining a performance level further comprises determining a desired performance level, where the desired performance level is dependent on the current performance level. The determining a desired performance level can include comparing the current performance level to one or more threshold performance levels to provide a comparison and selecting a desired performance level based on the comparison. The comparing the current performance level to the threshold performance level can comprise comparing the current performance level to the threshold performance level, wherein the threshold performance level is dependent on at least one of thread preemptions and thread priorities as determined by the monitoring thread activity.

FIG. 5 begins at 503 by getting or setting performance to current performance, i.e., the last calculated ratio as above described and setting preempt to preemption rate as last observed. At 505 the current performance is compared to a threshold performance level of, e.g., 70%. If the current performance is not greater than 70%, the process moves to 507 where the current performance is compared to another threshold performance level, e.g. 50%. If the current performance is not less than 50%, it is judged appropriate and the desired performance is set to the current performance at 509. If the current performance is judged to be too low, i.e., less than 50% in this example, the performance is set to the greater or maximum of 0, and current performance minus difference between a constant, i.e., 60% and current performance at 511 with the result at 511 provided at 509.

If the current performance is greater than 70% at 505, a new performance is determined at 513. The new or desired performance is selected as the minimum or lesser of current performance + preempt and 100% and this value is returned or provided at 509. The evaluation at 513 explicitly shows one embodiment of accounting for preemption rates.

Given the above discussions, it will be appreciated that the simple process reflected in FIG. 5 provides a non-linear map between measured or current performance and desired performance. This process is suitable for DVFS functions or hardware that have discrete set points, e.g. two set points, i.e., 100% and 50% (in addition to sleep or 0%). Generally the process of FIG. 5 returns a desired performance between “0” and “100”. How closely the DVFS hardware gets set to the desired performance level can depend on the number of set points provided by the hardware.

Other processes may be used to provide or determine a desired performance. For example, if the current performance is outside of a range (over or under), the desired performance can, respectively, be selected as an increment or decrement to a present performance setting. The observed or current performance can be augmented with additional preemption rate data with the sum used to make increment or decrement decisions.

Various activities can be undertaken by a processor during which voltage and frequency are not allowed to change, e.g., during DMA activity the voltage and frequency can not be changed for typical systems. Thus and as will be further discussed below, the PK implements an asynchronous interface with the DVFS driver.

Referring to FIG. 6, additional details for a portion of an interface between the performance kernel and a DVFS function in accordance with one or more embodiments will be discussed and described. The DVFS driver interface is through a common memory with signaling through an event. The PK provides a simple software interface to access and synchronize the data in the common memory.

FIG. 6 shows the OS kernel 105 and the PK interface 113 with the PK interface accessing common memory 205 to store, e.g., desired performance or calculated current performance or read actual or actual current performance and other DVFS parameters (DFVS hardware set points and the like). As an example, once the PK has provided an updated desired performance to common memory 205 an event 607 is sent to the DVFS driver 603. Responsive to the event 607, the DVFS driver can retrieve the desired performance from common memory 205 and change the voltage frequency settings for the DVFS hardware. Voltage frequency control is ordinarily done in steps which are predetermined by the hardware (voltage frequency set points).

Various functions are provided are provided to support the software interface and more specifically:

HANDLE IPWR_Init(IPR_SHARED**pIprCommon);

### This function will initialize the common memory section and wait for the iPower kernel to indicate readiness to send updates to the driver side.

void IPWR_Handshake(IPR_SHARED**pIprCommon);

This function will indicate to the iPower kernel that the DVFS driver is ready to accept DVFS notifications and it will also convey the number of steps supported by the DVFS driver. Before calling this function, fill in the DVFS section in the common area with the steps supported by the DVFS driver. The iPower kernel needs to know the DVFS capabilities supported by this driver.

void IPWR_DeInit(IPR_SHARED**pIprCommon);

### This function will release the common memory section and indicate to the iPower kernel that the DVFS driver is not available anymore.

An example of pseudo code showing how to use the provide interfaces is shown below:

```
/* Globals */
static IPR_SHARED *gpIprCommon;
DWORD WINAPI IPRIstThread(LPVOID lpParameter)
{
  IPRSTRUCT *pIpr = (IPRSTRUCT*) lpParameter;
  HANDLE hEvent = NULL;
  DWORD dwWait = INFINITE;
  hEvent = IPWR_Init(&gpIprCommon);
  if (!hEvent)
    return FALSE;
  // Init DVFS Parameters in the common memory.
  gpIprCommon->dvfs.dwCount = 2;
  gpIprCommon->dvfs.dwArgs[0] = 50;
  gpIprCommon->dvfs.dwArgs[1] = 100;
  // Notify the kernel that we are done.
  IPWR_Handshake(&gpIprCommon);
  do
  {
    if (WAIT_OBJECT_0 == WaitForSingleObject(hEvent, dwWait))
    {
    if (!pIpr->bStop)
    {
      // Do all the DVFS worke here
      DWORD dwRequestIndex = gpIprCommon-
      >dwRequesedFreqIndex;
      DWORD dwRet = DvfsChange( );
      if (dwRet)
      {
        // Sucess
        gpIprCommon->dwActualFreq = gpIprCommon-
        >dvfs.dwArgs[dwRequestIndex];
      }
    }
    }
  } while (!pIpr->bStop);
  return TRUE;
}
```

The PK interface provides a number of functions to map performance values to one of the supported steps and back to a performance value. These functions include:

IPWR_DVFS_NotifyDriver( )

### This function sends an event to the DVFS driver to make a change to the voltage and frequency based on the performance level requested by the prediction algorithm, i.e., desired performance level algorithm.

IPWR_DVFS_SetFrequency( )

### The prediction algorithm uses this function to set the performance level to a value between 0 and 100%. This function will also call IPWR_DVFS_NotifyDriver to trigger the DVFS driver to perform the requested change if any.

IPWR_DVFS_FrequencyToIndex( )

### This is used internally to map a performance level to one of the supported steps or set points.

IPWR_DVFS_GetCurrentFrequency( )

This function returns the current performance level of the actual hardware, not the requested performance level. There can be a delay between the request and the execution of the change in voltage/frequency.

IPWR_DVFS_Snap( )

### This function is used internally to map a performance level to one of the supported performance levels.

IPWR_DVFS_Step( )

The prediction algorithm uses this function to step the performance level up or down one level. This function will also call IPWR_DVFS_NotifyDriver to trigger the DVFS driver to perform the requested change if any.

PK Interface

### To use PK as a complete power management solution that will calculate performance and predict future desired performance levels we need to call a two stage initialization process.

IPWR_OsInit

This function is called early in PK initialization with a zero argument, i.e., IPWR_OsInit(0) to do the low level initialization of the PK interface and then again when the PK interface is fully initialized with a non zero argument, i.e., IPWR_OsInit(1) to initialize IPC interfaces (events).

Another application can use the PK as an interface to the OS kernel if ht ePK is initialized to receive appropriate thread events. The events will be in the form of simple callbacks to the application when anything related to threads changes. To use this callback interface the application needs to create 3 functions that will be called by the PK after registration with the OS kernel. These functions are:

New Thread

This function will be called when the OS create a new thread. The only argument to this function will point to the thread local storage provided by the PK. The user should initialize the user area in the thread local storage if needed. PK will clear this block to zero. The only attribute that will be initialized by PK is the unique ID for this thread.

Pre Thread Switch

This function will be called just before the actual switch to a new thread. The argument to this function will be a pointer to the thread local storage of the current active thread.

Thread Switch

This function will be called with 2 arguments, previous thread and current thread. The first argument will be a pointer to the thread local storage of the thread that is switched out and the second argument is a pointer to the thread local storage of the new thread that is about to start running. PK will update the preempt flag of the previous thread that is switched out.

The PK is initialized by calling IPWR_OAL_Init. This is the main initialization function of the PK and requires 3 arguments, i.e., the callback functions noted above. For example pseudo code for initialization can be as follows.

```
static void ThreadCreate(void *pTls)
{
}
static void PreThreadSwitch(void *pTls)
{
}
static void ThreadSwitch(void *pFromTls, void *pToTls)
{
    DWORD predicted_work = 0;
    predicted_work = Predict( );
    // Set performance level
    IPWR_DVFS_SetFrequency(predicted_work);
}
// Call this function early in the initialization process.
IPWR_OAL_Init(ThreadCreate, PreThreadSwitch, ThreadSwitch);
...
...
// Call this function when the system is initialized.
// We need to initialize IPC interfaces (events)
IPWR_OS_Initialized( )
```

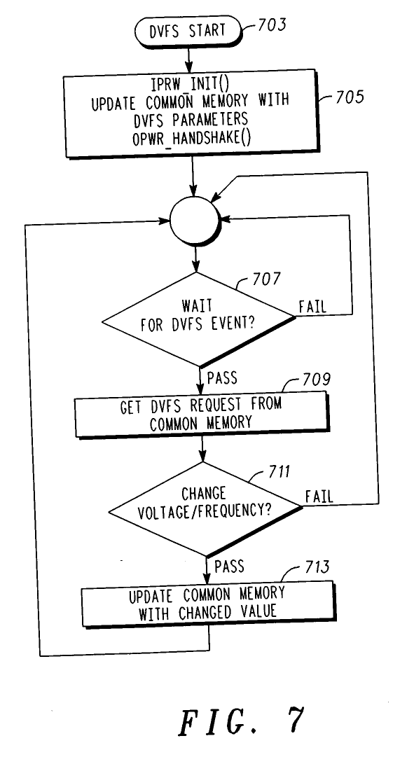

Referring to FIG. 7, a flow chart illustrating representative methods of implementing the interface at the DVFS function/driver in accordance with one or more embodiments will be discussed and described. FIG. 7 begins at 703 and then shows PK, common memory, etc. initialization with a handshake at 705. Next a loop which is waiting for a DVFS event is entered 707. Once a DVFS event is detected, the DVFS request is retrieved 709 from common memory. This is typically a new desired performance level. Given the request the voltage frequency is changed at 711. If this fails the process returns to 707. If the change is successful the DVFS driver will update the common memory with the changed voltage frequency value at 713.

The above discussions have shown and discussed varying embodiments of methods and systems for assessing performance of a processor in a thread based operating system. In varying embodiments the system can comprises software instructions suitable for execution on the processor or other processor. The system, when executing is arranged and configured to perform various methods with one such method comprising: registering with an operating system kernel as a coprocessor; capturing, responsive to the registering, thread events for the processor; managing memory allocation corresponding to a multiplicity of threads; monitoring thread activity for the multiplicity of threads; tracking, responsive to the monitoring thread activity, thread run time and thread idle time over a predetermined number of thread events; and determining a performance level for the processor based on the thread activity. In one or more embodiments of the system, the methods can include one or more of the additional processes or more detailed processes noted above. For example, the managing memory allocation can further include requesting additional memory for storing additional thread specific information, e.g., time stamps, IDs, Run or Idle times, additional thread activity information, and intermediate and final results of the determining a performance level.

The processes and systems, discussed above, and the inventive principles thereof are intended to and can alleviate issues caused by prior art techniques for assessing processor performance. Using these principles of gaining access to thread information, i.e., by registering as a coprocessor or low level changes to an OS kernel and tracking relevant portions of the thread information can quickly yield accurate current performance level estimates and desired or predicted performance levels with relatively minimal costs and the like.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method of assessing performance of a processor in a thread based system, the method comprising:
registering with an operating system kernel as a coprocessor;
managing memory allocation corresponding to a multiplicity of threads;
capturing, responsive to the registering, thread events for the processor;
monitoring thread activity for the multiplicity of threads;
tracking thread run time and thread idle time based on the monitoring thread activity; and
determining a performance level for the processor based on the thread activity.

2. The method of claim 1 wherein the determining a performance level further comprises determining a current performance level based on the monitoring thread activity.

3. The method of claim 2 wherein the determining a current performance level further comprises tracking thread run time and tracking thread idle time over a predetermined number of thread events.

4. The method of claim 3 wherein the tracking thread run time and the tracking thread idle time over a predetermined number of thread events further comprises using a sliding window that encompasses the predetermined number of thread events and updating the thread run time and thread idle time by any difference corresponding to an old thread event leaving the sliding window and a new thread event arriving in the sliding window.

5. The method of claim 1 wherein the monitoring thread activity further comprises monitoring thread preemptions.

6. The method of claim 1 wherein the monitoring thread activity further comprises monitoring thread priorities.

7. The method of claim 1 wherein the determining a performance level further comprises determining a desired performance level based on the thread activity.

8. The method of claim 7 wherein the determining a desired performance level further comprises determining a current performance level, the current performance level corresponding to the thread run time and the thread idle time, the desired performance level dependent on the current performance level.

9. The method of claim 7 wherein:
the monitoring thread activity further comprises tracking thread preemption; and
the determining a desired performance level based on the thread activity further comprises determining a desired performance level based on the thread preemption.

10. The method of claim 1 further comprising providing the performance level to a predetermined memory location, the performance level corresponding to a current performance level.

11. The method of claim 1 further comprising providing the performance level to a predetermined memory location, the performance level corresponding to a desired performance level, wherein the desired performance level is available to a Dynamic Voltage/Frequency Scaling driver to set the performance level of the processor.

12. A method of assessing performance of a processor in a thread based system, the method comprising:
managing memory allocation corresponding to a multiplicity of threads;
monitoring thread activity for the multiplicity of threads;
tracking, responsive to the monitoring thread activity, thread run time and thread idle time over a predetermined number of thread events; and
determining a performance level for the processor based on the thread activity.

13. The method of claim 12 wherein the determining a performance level occurs at a first rate when the thread events occur at a first event rate and at a second rate when thread events occur at a second event rate.

14. The method of claim 12 wherein the tracking thread run time and the tracking thread idle time over a predetermined number of thread events further comprises using a sliding window that encompasses the predetermined number of thread events and updating the thread run time and thread idle time by any difference corresponding to an old thread event leaving the sliding window and a new thread event arriving in the sliding window.

15. The method of claim 12 wherein the determining a performance level further comprises determining a current performance level based on the monitoring thread activity.

16. The method of claim 15 wherein the determining a performance level further comprises determining a desired performance level, the desired performance level dependent on the current performance level.

17. The method of claim 16 wherein the determining a desired performance level comprises comparing the current performance level to a threshold performance level to provide a comparison and selecting a desired performance level based on the comparison.

18. The method of claim 17 wherein the comparing the current performance level to the threshold performance level further comprises comparing the current performance level to the threshold performance level, wherein the threshold performance level is dependent on thread preemptions as determined by the monitoring thread activity.

19. A system for assessing performance of a processor in a thread based operating system, the system comprising software instructions suitable for execution on the processor, the system, when executing, configured to perform a method comprising:
registering with an operating system kernel as a coprocessor;
managing memory allocation corresponding to a multiplicity of threads;
capturing thread events for the processor;
monitoring thread activity for the multiplicity of threads;
tracking, responsive to the monitoring thread activity, thread run time and thread idle time over a predetermined number of thread events; and
determining a performance level for the processor based on the thread activity.

20. The system of claim 19 wherein the managing memory allocation further comprises requesting additional memory for the tracking thread run time and thread idle time.
